(19) United States
(12) Patent Application Publication
(10) Pub. No.: US 2026/0223765 A1
(43) Pub. Date: Aug. 6, 2026

(54) VOLUMETRIC SEED METER AND RETRO-FIT VOLUMETRIC SEED METER FOR AGRICULTURAL PLANTING IMPLEMENT

(71) Applicant: Kinze Manufacturing, Inc., Williamsburg, IA (US)

(72) Inventors: Matthew Wilhelmi, Williamsburg, IA (US); Brad Kruse, Williamsburg, IA (US); Greg Ryan, Williamsburg, IA (US)

(21) Appl. No.: 19/531,004

(22) Filed: Feb. 5, 2026

Related U.S. Application Data
(60) Provisional application No. 63/754,274, filed on Feb. 5, 2025.

(51) Int. Cl. A01C 7/12; A01C 7/04; A01C 7/14

(52) U.S. Cl. CPC A01C 7/122; A01C 7/0443; A01C 7/14

(57) ABSTRACT

Air seed meters are traditionally used to meter seed, such as corn and soybeans, while seeders or seed drills are used for smaller cereal seeds. The same air seed meter can be used for cereal seeds as well, however, with minimal adjustments. A replacement seed disk can be used that includes paddles or the like. The seed meter is operated in a different manner, such as in an opposite direction from the air seed meter operation, to allow the same meter to be used with the replacement disk to allow the meter to be used as a volumetric metering system. This will allow for quick and easy changes to a meter to plant different seed types and by changing the operation of the meter.

### CROSS REFERENCE TO RELATED APPLICATIONS

This application claims priority under 35 U.S.C. § 119(e) to provisional patent application U.S. Ser. No. 63/754,274, filed Feb. 5, 2025. The provisional patent application is hereby incorporated by reference in its entirety herein, including without limitation: the specification, claims, and abstract, as well as any figures, tables, appendices, or drawings thereof.

### TECHNICAL FIELD

The present disclosure relates generally to agricultural implements. More particularly, but not exclusively, the disclosure includes embodiments related to agricultural planting implements, including precision and seeding planting implements.

### BACKGROUND

The background description provided herein gives context for the present disclosure. Work of the presently named inventors, as well as aspects of the description that may not otherwise qualify as prior art at the time of filing, are neither expressly nor impliedly admitted as prior art.

Agricultural involves the planting and harvesting (sowing and reaping) of crops. Crops are planted by placing their seed(s) in the ground at desired agronomic conditions, including, but not limited to, depth, climate, spacing, and the like. Different crops can be planted in different manners, which can include precision planting practices and volumetric (also referred to as seeding) practices.

Precision planting may refer to the practice of planting certain crops, such as corn and soybeans, in a controlled manner to place the seeds in desired spacing to optimize the conditions to achieving best yields. The spacing and population of the seeds have been determined over time by agronomists, farmers, and others to ensure that the growing crops have enough root and canopy space, which can aid in optimizing growing conditions. Implements have been developed and finetuned to be able to achieve the desired planting conditions (e.g., depth, spacing, compaction of soil) for the crops. For example, U.S. Pat. No. 9,282,691, herein incorporated by reference in its entirety, discloses an implement with seed meters that receive seed and then singulate the seed(s) so that a desired number of seeds are released from the seed meter as the implement travels through a field. The meter includes a disk and a pressure differential (e.g., vacuum) at the disk, to hold seed at specific places until the seed can be released. Other types include finger-like members that hold a seed or seeds at a location until they are released to the ground. The seed meter controls the seed being planted in a furrow of the field in a precise manner through a seed tube, wherein the seed essentially falls via gravity to the ground. Note that the seed meters of the '691 patent can be changed for different seed types, such as for corn and/or soybeans. However, the operation of the meter in general will not change when changing between these types of seeds.

Another planting implement is disclosed in U.S. Pat. No. 10,842,072, also incorporated by reference in its entirety. The implement in the '072 patent is also set up for precision planting of corn, soybeans, and the like. However, the implement in the '072 patent includes a seed meter and conveying member that takes seed from the meter to the ground in a controlled manner. The meter of the '072 includes vacuum pressure to hold the seed(s) at the seed disk until such time that the seed is to be released and placed in the field. The conveyor allows the seed to be precisely released at a speed matching the traveling speed of the tractor/planter combination to reduce bounce or roll in the furrow. In addition, the implement of the '072 patent allows for high speed, precision planting, such as at speeds over 10 miles per hour. Similar to the '691 patent, the seed meter of the '072 patent includes seed discs that are set up for corn, soybeans, and the like, which can be quickly and easily swapped depending on the type of seed.

However, as noted, seeding is generally operated differently. In seeding, the volume of seed being released via an agricultural implement is controlling, as opposed to the exact placement in the ground. Seeding is generally utilized for crops that may be referred to as cereal grains, including, but not limited to wheat, rye, barley, canola, and the like. These seeds are generally smaller and the key for placement is maintaining an amount of seeds being released by an implement as it moves through a field. Traditionally, seed drills are used to plant such seeds.

Traditionally, precision seed meters and seeders are not equivalents in that the operations of the seed meters needed for each are not readily compatible. Instead, changes would be needed in order to use an implement such as that disclosed in the '691 or '072 patent to be able to operate as a seeder. It would also take much time and effort to revert such a meter back to a pressure (vacuum or positive pressure) meter.

Thus, there exists a need in the art for an agricultural implement including the ability to release seeds to be more easily transitional to be able to plant seeds in a precise manner, such as using air pressure, and also to be able to operate as a volumetric type meter.

### SUMMARY

The following objects, features, advantages, aspects, and/or embodiments are not exhaustive and do not limit the overall disclosure. No single embodiment need to provide each and every object, feature, or advantage. Any of the objects, features, advantages, aspects, and/or embodiments disclosed herein can be integrated with one another, either in full or in part.

It is a primary object, feature, and/or advantage of any of the embodiments of the present disclosure to improve on or overcome the deficiencies in the art.

It is a further object, feature, and/or advantage of the present disclosure to provide a seed meter that can be operated as a precision air pressure meter and also as a volumetric meter. For example, the meter may operate in a number of configurations, wherein a first configuration utilizes a pressure difference (e.g., vacuum) to hold and release seeds, and in a second configuration, utilizes brushes without any pressure difference to hold and release seeds.

It is still yet a further object, feature, and/or advantage of the present disclosure to transition a seed meter between pressure meter and volumetric meter with minimal changes made to the meter.

It is yet another object, feature, and/or advantage of the present disclosure to utilize a volumetric type seed meter with gravity drop tubes or high speed planting systems with controlled seed to ground conveyance systems.

The seed meters and/or row units disclosed herein can be used in a wide variety of applications. For example, the embodiments disclosed will allow for quicker and easier transitioning between precision seeding type meters and volumetric type meters, regardless of the type of seed delivery (e.g., on row hoppers or bulk fill systems) and seed to ground systems (gravity drop tubes, controlled seed to ground belts, brushes, or other conveyors) provided.

It is preferred the seed meters and row units provided be safe, cost effective, accurate, and durable.

Methods can be practiced which facilitate use, manufacture, assembly, maintenance, and repair of a seed meter and/or implement row unit, which accomplish some or all of the previously stated objectives.

The seed meters, or aspects thereof, can be incorporated into systems which accomplish some or all of the previously stated objectives.

According to some aspects of the present disclosure, a seed meter for use with an agricultural implement comprises a seed meter housing; a seed disk rotatably mounted in the seed meter housing; wherein the seed meter operable in a first configuration wherein the seed disk rotates in a first direction to meter and release seeds, and a second configuration wherein the seed disk rotates in a second direction that is opposite the first direction to meter and release seeds.

According to at least some of the embodiments of the present disclosure, in the first configuration, the seed disk is an air seed disk utilizing an air pressure differential to hold seeds at the disk.

According to at least some of the embodiments of the present disclosure, the seed meter further comprises a seed singulator to regulate seed at seed cells of the seed disk.

According to at least some of the embodiments of the present disclosure, in the second configuration, the seed disk is a volumetric seed disk comprising a plurality of generally radially spaced paddles and wherein seed is held between subsequent paddles during movement of the disk.

According to at least some of the embodiments of the present disclosure, the seed meter further comprises a brush block insert near a discharge point to direct seed towards the discharge point in the seed meter housing.

According to at least some of the embodiments of the present disclosure, the brush block insert include a brush to aid in controlling the number of seeds between subsequent paddles.

According to at least some of the embodiments of the present disclosure, the seed meter housing comprises a seed chute for directing seeds from the seed meter.

According to at least some of the embodiments of the present disclosure, the seed meter further comprises a seed tube adjacent the seed meter housing to receive seed from the seed meter and to direct towards a furrow.

According to at least some of the embodiments of the present disclosure, the seed meter further comprises a seed to ground system adjacent the seed meter, the seed to ground system comprising a housing with an endless member therein, the endless member to control the movement of the seed from the seed meter through the housing and to the ground.

According to at least some of the embodiments of the present disclosure, the endless member of the seed to ground system is rotatable in a speed wherein the release of the seed therefrom includes a horizontal velocity that is equal and opposite to a horizontal speed of the agricultural implement.

According to at least some of the embodiments of the present disclosure, the endless member comprises a flighted belt.

According to at least some of the embodiments of the present disclosure, the endless member is connected to an electric motor to provide movement for the endless member.

According to still additional aspects of the disclosure, a seed meter comprises a seed meter housing; a first seed disk capable of being rotatably mounted in the seed meter housing; and a second seed disk capable of being rotatably mounted in the seed meter housing; wherein the first seed disk is selected when the seed meter is operated as an air seed meter; wherein the second seed disk is selected when the seed meter is operated as a volumetric seed meter; and wherein the first and second seed disks are rotated in the same or opposite directions in the seed meter housing.

According to at least some of the embodiments of the present disclosure, the first seed disk comprises a plurality of radially spaced seed cells comprising apertures passing through the seed disk.

According to at least some of the embodiments of the present disclosure, the second seed disk comprises a plurality of radially spaced paddles to hold a volume of seed therebetween as the second seed disk rotates in the seed meter.

According to at least some of the embodiments of the present disclosure, the seed meter housing comprises a seed chute for directing seeds from the seed meter.

According to at least some of the embodiments of the present disclosure, the seed meter further comprises a seed tube adjacent the seed meter housing to receive seed from the seed meter and to direct towards a furrow.

According to at least some of the embodiments of the present disclosure, the seed meter further comprises a seed to ground system adjacent the seed meter, the seed to ground system comprising a housing with an endless member therein, the endless member to control the movement of the seed from the seed meter through the housing and to the ground.

According to at least some of the embodiments of the present disclosure, the endless member of the seed to ground system is rotatable in a speed wherein the release of the seed therefrom includes a horizontal velocity that is equal and opposite to a horizontal speed of the agricultural implement.

These and/or other objects, features, advantages, aspects, and/or embodiments will become apparent to those skilled in the art after reviewing the following brief and detailed descriptions of the drawings. The present disclosure encompasses (a) combinations of disclosed aspects and/or embodiments and/or (b) reasonable modifications not shown or described.

### BRIEF DESCRIPTION OF THE DRAWINGS

Several embodiments in which the present disclosure can be practiced are illustrated and described in detail, wherein like reference characters represent like components throughout the several views. The drawings are presented for exemplary purposes and may not be to scale unless otherwise indicated.

FIG. 1 is a perspective view of an agricultural planting implement.

FIG. 2 is a side elevation view of a row unit for use with an agricultural implement.

FIG. 3A is a perspective view of a portion of a seed meter.

FIG. 3B is a perspective view of a seed disk utilizing a pressure differential for use with the meter of FIG. 3A.

FIG. 3C is a side elevation view of a seed meter utilizing an air pressure differential to meter seeds for placement in the ground.

FIG. 3D is a front sectional view of FIG. 3C showing portions of the seed meter housing and volumetric seed disk positioned therein.

FIG. 4A is a perspective view of a seed meter similar to FIG. 3A.

FIG. 4B is a perspective view of a volumetric seed disk for use with the seed meter housing of FIG. 4A.

FIG. 4C is a side elevation view of the seed meter with volumetric seed disk.

FIG. 4D is a front sectional view of FIG. 4C showing portions of the seed meter housing and volumetric seed disk positioned therein.

FIG. 5 is an enlarged view of a portion of a volumetric seed disk according to aspects of the present disclosure.

FIG. 6 is a view of a close up portion of a volumetric seed disk moving in a seed meter according to aspects of the present disclosure.

FIG. 7 is a view similar to FIG. 6, but also showing seeds being moved by the volumetric seed disk in the seed meter.

FIG. 8 is a schematic view of a volumetric row unit utilizing a gravity seed tube delivery system.

FIG. 9 is a schematic view of a volumetric row unit utilizing a controlled seed to ground delivery system in the form of an endless member.

FIG. 10 is a view of a portion of a fluted feed roll used to meter seeds into a gravity seed tube for delivery to the ground.

FIG. 11 is a view of the fluted feed roll of FIG. 10 delivering seed into a funnel.

FIG. 12 is a view showing an electric motor used to operate the fluted feed roll according to aspects of the disclosure.

FIG. 13 is a view showing the fluted feed roll in combination with a seed to ground system including an endless member therein.

FIG. 14 is a view showing another view of the fluted feed roll.

An artisan of ordinary skill in the art need not view, within isolated figure(s), the near infinite distinct combinations of features described in the following detailed description to facilitate an understanding of the present disclosure.

### DETAILED DESCRIPTION

Unless defined otherwise, all technical and scientific terms used above have the same meaning as commonly understood by one of ordinary skill in the art to which embodiments of the present disclosure pertain.

The terms “a,” “an,” and “the” include both singular and plural referents.

The term “or” is synonymous with “and/or” and means any one member or combination of members of a particular list.

As used herein, the term “exemplary” refers to an example, an instance, or an illustration, and does not indicate a most preferred embodiment unless otherwise stated.

The term “about” as used herein refers to slight variations in numerical quantities with respect to any quantifiable variable. Inadvertent error can occur, for example, through use of typical measuring techniques or equipment or from differences in the manufacture, source, or purity of components.

The term “substantially” refers to a great or significant extent. “Substantially” can thus refer to a plurality, majority, and/or a supermajority of said quantifiable variables, given proper context.

The term “generally” encompasses both “about” and “substantially.”

The term “configured” describes structure capable of performing a task or adopting a particular configuration. The term “configured” can be used interchangeably with other similar phrases, such as constructed, arranged, adapted, manufactured, and the like.

Terms characterizing sequential order, a position, and/or an orientation are not limiting and are only referenced according to the views presented.

The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

The present disclosure is not to be limited to that described herein. Mechanical, electrical, chemical, procedural, and/or other changes can be made without departing from the spirit and scope of the present disclosure. No features shown or described are essential to permit basic operation of the present disclosure unless otherwise indicated.

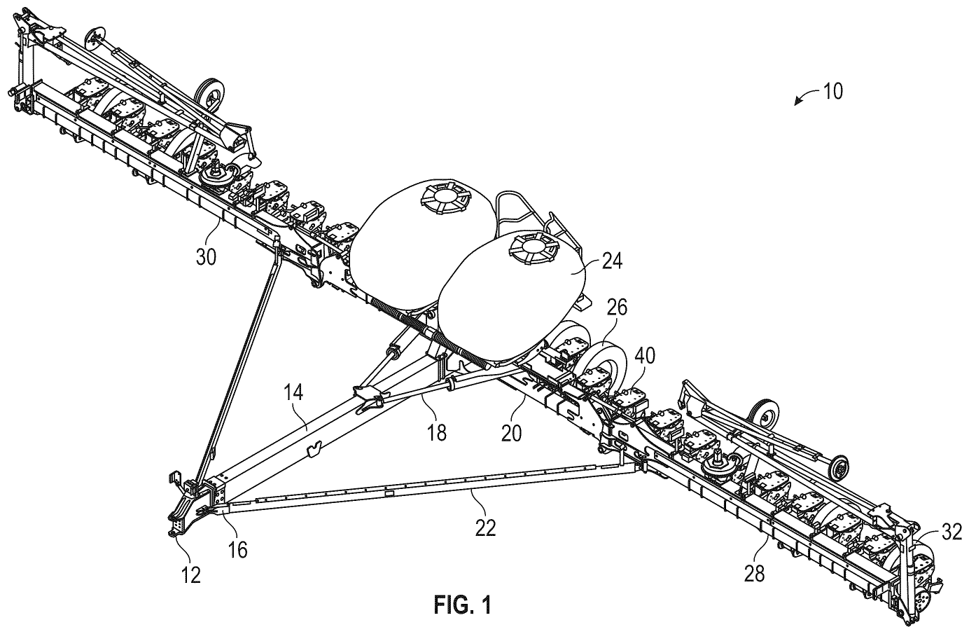

FIG. 1 shows an agricultural implement in the form of an agricultural planter 10 used to plant and fertilize seed in a controlled manner. The planter 10 as shown in FIG. 1 includes a tongue 14, which may be telescoping. The tongue 14 includes a first end 16 with an implement hitch 12 for attaching to a tow vehicle, such as a tractor, prime mover, or other vehicle. The opposite end 18 of the tongue 14 is attached to a toolbar 20. Draft links 22 are shown to be connected between the toolbar 20 and the tongue 14 and are used in conjunction with folding actuators to fold the toolbar 20 in a frontward manner. The tongue 14 may be a telescoping tongue in that it can extend or retract to allow for the front folding of the toolbar 20. The planter 10 may also be a lift and rotate, rear fold, vertical fold, narrow row, or generally any other type of planter.

In addition, as noted, the implement may be a different type of ground engaging implement. For example, agricultural sprayers, plows, tillage equipment, seeders, drills, fertilizers, or other types of implements that can utilize the novel features disclosed herein should be considered a part of the disclosure.

The toolbar 20 includes first and second wings extending generally outwardly therefrom. The toolbar 20 includes central hoppers 24, which contain seed or other granules/particulate used with ground engaging tools, such as seed for planting. A plurality of transport wheels 26 also are connected to the toolbar 20. The first and second wings are generally mere images of one another in mirrored fashion. The wings include first and second wing toolbars, which are essentially extensions from a central toolbar portion. Attached along the toolbar 20 as well as the first and second wing are a plurality of row units 40. When the implement is a planting unit, the row units will include seed meters, ground engaging tools, and/or other components used for planting, tilling, and fertilizing seed in a controlled manner, such as many components that will be described in more detail herein. Also connected to the first and second wings are first and second markers. The markers include actuators, which are used to raise and lower the markers. The markers can be lowered to provide guidance for the edge of a planter for use in planting. When not required, the markers can be lifted to a position as that shown in FIG. 1 to move the markers out of the way.

Also shown in FIG. 1 are a plurality of fans as well as a plurality of wheels 32. The wings may also include actuators to raise and lower or otherwise provide a downward force on the wings. Therefore, as is shown in FIG. 1, there are a multiplicity of components of the planting implement 10. The components may include moving parts, such as the actuators used to move the wings, markers, row units, etc., while also providing additional functions. For example, the fans are used to provide a pressure in the seed meters to aid in adhering seed to a seed disk moving therein. The seed meters may be electrically driven in that a motor, such as a stepper motor, can be used to rotate the seed meters to aid in adhering seed thereto and to provide for dispensing of the seed in a controlled manner for ideal spacing, population, and/or placement. Other features may include actuators or other mechanisms for providing down force to the row units 40. Lights may also be included as part of the planter.

Additionally, an air seed delivery system may be provided between the central hoppers 24 and any plurality of seed meters on the row units 40 in that the air seed delivery system provides a continued flow of seed to the row units on an as needed manner to allow for the continuous planting of the seed via the seed meters on the row units. Thus, the various controls of the planter may require or otherwise be aided by the use of an implement control system. The implement control system can aid in controlling each of the functions of the implement or planter 10 so as to allow for the seamless or near seamless operation with the implement, and also provides for the communication and/or transmission of data, status, and other information between the components.

As will be appreciated, the planter need not include all of the features disclosed herein and may also include additional or alternative features as those shown and/or described. The foregoing has been included as an exemplary planter, and it should be appreciated that generally any planter from any manufacturer and any add-ons or aftermarket components may be included in any planter that encompasses any of the aspects of the invention.

A planter 10 such as that shown can be pulled by the tow vehicle, such as the tractor. In addition, the planter 10 could be pulled by or itself be a self-propelled, autonomous tug unit, rather than an operator-driven vehicle, such as the tractor, such as the one shown and described in co-owned U.S. Pat. No. 10,575,453, which is herein incorporated by reference in its entirety. The rear drivable wheels and front steerable wheels can be substituted for tracks, regardless of whether said tracks are implemented on an operator-driven vehicle or a self-propelled vehicle.

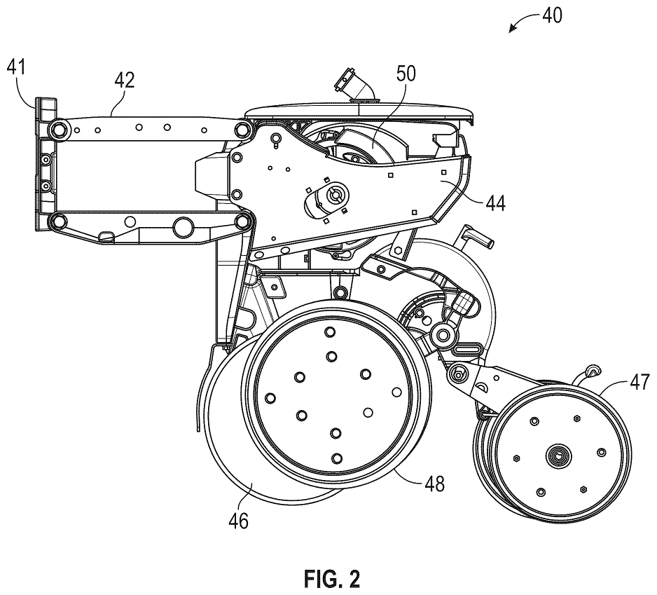

FIG. 2 is a side elevation view of a row unit 40. The row unit 40 includes a seed meter 50, furrow opener 46 and furrow closer 47. The row unit 40 also includes standard features such as frame 44, linkage 42, mount 41 for mounting to the planter 10, gauge wheels 48, and depth control mechanism. The gauge wheels 48 and depth control mechanism work together to control the depth of the furrow or trench created by the opener 46. Furthermore, the row unit 40 is connected to a seed supply, such as the central hoppers 24 or on-row hoppers, which can provide the seed meter of each row unit 40 with seed to be planted. Alternatively, the row hopper may be a self-contained unit unconnected to a central hopper.

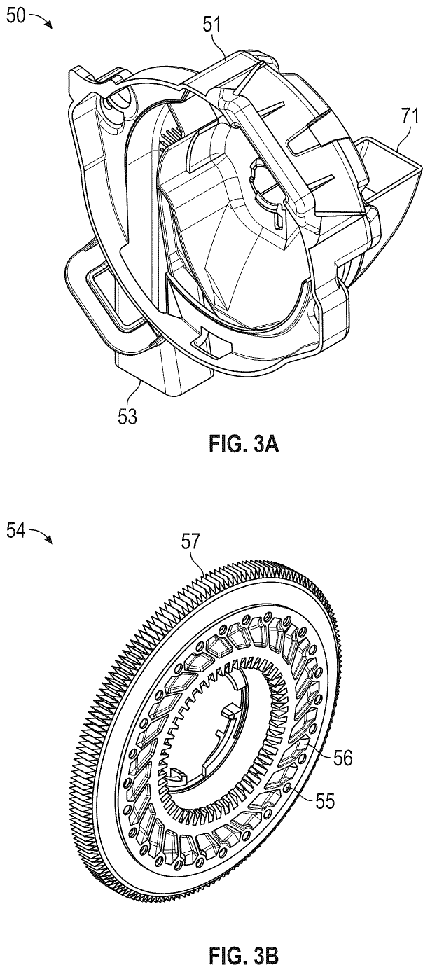

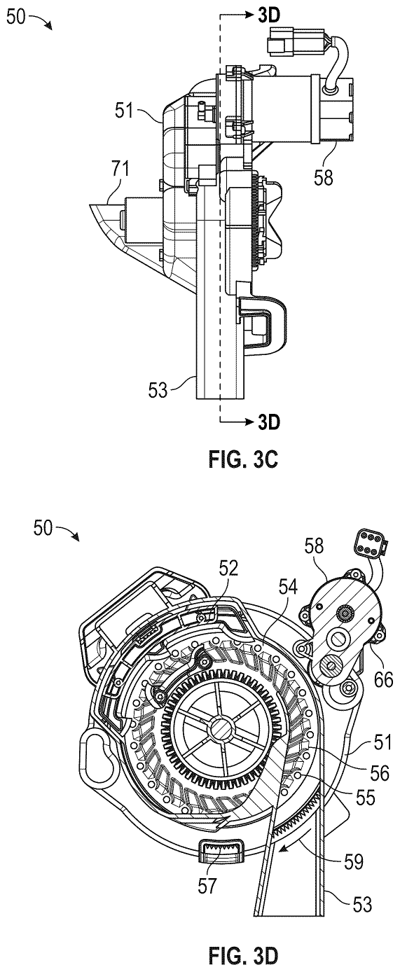

FIGS. 3A-3D show aspects of a traditional air seed meter, such as that shown in the '691 patent. The seed meter 50 includes a seed meter housing 51 that houses a rotatable seed disk 54 therein. The seed disk 54 separates the seed meter housing 51 into a seed side and a pressure side. A pressure source, such as a vacuum (not shown) is used to apply a pressure differential at the seed disk 54 via seed cells 55. As shown, there are a number of radially spaced seed cells 55 through the seed disk 54. The vacuum creates a pressure differential at the seed cell to essentially hold a seed at the cell until such time that the seed is released, either by force or by removal of the pressure differential.

The seed meter housing 51 shown in FIG. 3A is the seed side, wherein seed is supplied to the meter. This can be via on-row hopper or by a bulk fill system, such as an air seed delivery system that supplies seed to the meter in an on-demand manner. Seed can collect in the meter at a seed pool. The disk 54 rotates in the housing and the cells 54 pass through the seed pool. The pressure differential at the cells causes a seed to be held at the cell during continued rotation. To aid in moving the seeds in the pool to a seed cell 54, pockets 56 are formed on the disk 54. The pockets 56, such as disclosed in the '691 patent, are flow directing in that they agitate the seed and encourage seed in the pool to move towards the cells for more efficient placement of the seed at a cell.

The seed disk 54 is rotated via an electric motor 58. In the figures, the disk includes an outer periphery of driven teeth 57 that correspond to an output of the electric motor 58. The motor 58 drives the disk to rotate at a desired rotational velocity in the meter housing, which can be based upon the travel speed of the planting implement in the field to ensure that the seed is spaced accordingly.

Moving to FIG. 3D, a sectional view of the meter 50 with the disk 54 is shown. The meter is operated in a first configuration wherein the disk 54 is rotated in a direction shown by the arrow 59 in FIG. 3D. As noted, the disk 54 will rotate in the direction of the arrow 59 to move the seed cells 55 and pockets 56 through seed in a seed pool. The pressure difference causes the seed to be held at the seed cells during continued rotation, which includes passing a seed singulator 52 in the seed meter housing. The singulator 52 can include one or more blades, brushes, or other mechanisms to ensure that the desired number of seeds are held at the seed cell (e.g., one seed per cell for corn seeds). The disk continues rotating with the seeds at the seed cells until a location at or near a three o'clock position (as looking at FIG. 3D), where the pressure is cut off. This removal of the pressure difference allows the seed to fall from the seed cell 55 and into and through a seed chute 59. The seed can then be directed to the furrow in the ground, such as by gravity tube or controlled seed to ground system, which can include an electrically driven endless member, such as a brush or flighted member.

The configuration shown in FIGS. 3A-3D is known and used generally for seeds such as corn, sunflower, soybeans, and the like. The disks can be swapped out to account for the different seed types (sizes, shapes, desired number, etc.), but the general operation of the meter is the same regardless of the seed type.

Other types of seed, such as cereal grains (wheat, rye, barley, canola, and the like) have generally required a different seed meter altogether. However, according to at least some aspects of the present disclosure, the same seed meter as shown and operationally described with respect to FIGS. 3A-3D can be utilized for the cereal grain type seeds, which are generally smaller and are released in a different manner. These seed types typically are released via a seeder or seed drill, wherein a desired number of seeds are released at a time as the implement moves through the field to attempt to achieve a certain population instead of the required spacing.

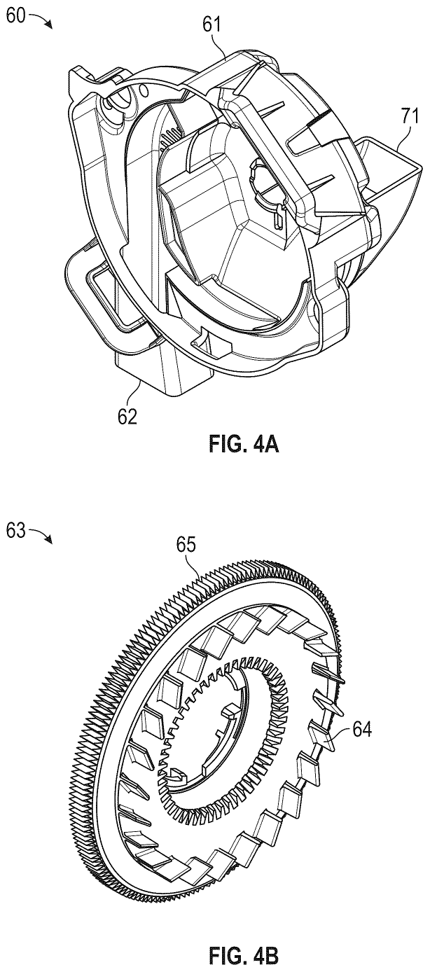

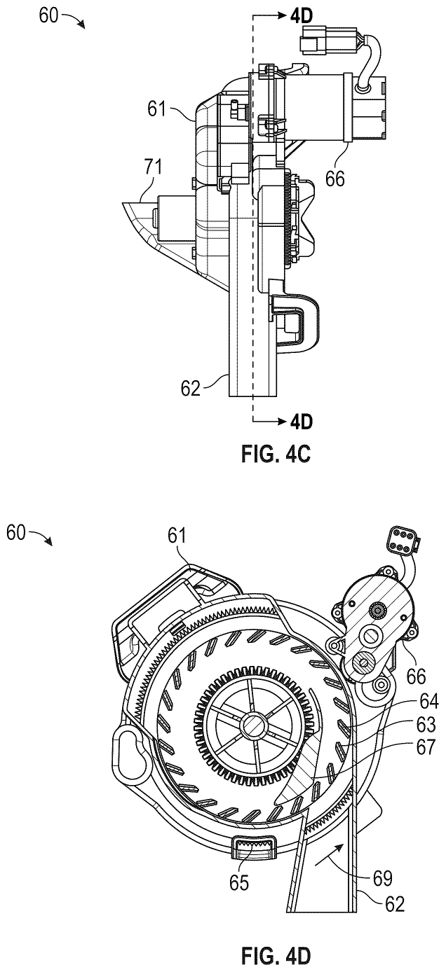

Therefore, to allow the seed meter 60 to operate in a second configuration, attention is given to FIGS. 4A-4D. The meter 60 is generally the same as the meter 50 previously disclosed. The meter 60 includes a meter housing 61 having a seed inlet 71 portion and a seed chute 62. The meter housing also still maintains the two sides.

A seed disk 63 is shown in FIG. 4B and differs from the disk previously disclosed. The seed disk 63 is circularly shaped and includes the outer periphery of gear teeth 65. This allows the disk to be driven by the output of the electric motor 66. However, instead of seed cells and pockets, the disk includes a number of radially positioned paddles 64. The paddles 64 extend from a face of the seed disk 63 and can be oriented at an angle to better operate, as will be understood. The exact shape, size, orientation, and height of the paddles may vary and are not to be limited by the configuration shown in the figures.

Moving to FIGS. 4C and 4D, operation of the seed meter 60 in the second configuration will be explained. The seed will be provided to the meter 60 at the seed inlet 71 via a bulk fill system (bulk hoppers 24 and an air seed delivery system) or by on-row hoppers at each of the row units. The electric motor 66 drives the seed disk 63 in the meter housing 61 in the direction shown by the arrow 62 in FIG. 4D. One thing to note is that this direction is opposite of that for the meter 50 in FIGS. 3A-3D.

Another change in the meters 50, 60 is the addition of an insert 67 in the meter housing 60. The insert 67 can include a brush portion 68 as well. As the seed disk 63 rotates, seed is collected between subsequent paddles. The insert 67 and/or brush 68 works as a control mechanism to control the number of seeds between the paddles. Thus, the paddles 64, the outer wall of the housing, and the insert 67 essentially create a closed area where the seed is collected and held to control the number of seeds. The continued rotation of the disk moves the seed past the insert to a location adjacent the seed chute 62. As the outer wall is now missing, the seed will fall from between the subsequent paddles 64 and into the seed chute 62, where it will be directed towards the field, such as via a gravity tube or a controlled seed to ground system. The size of the paddles and the positioning of the same will aid in controlling the number of seeds that are released from the meter 60 as the implement moves through the field. This is also controlled by the rotational velocity of the disk moving in the meter.

Thus, essentially the same meter can be operated in different configurations (e.g., different rotational directions) and with minimal change (e.g., changing the disk and adding/removing an insert) to allow for the same meter to be used to plant seeds such as corn and soybeans, as well as cereal grain type seeds. Not having to completely remove and replace the entire meter will save immense time and the ease of changing will also allow farmers to quickly and easily switch for planting different seed types. This will also reduce the number of seed meters that a farmer will need to purchase, which provides the advantage of keeping costs down.

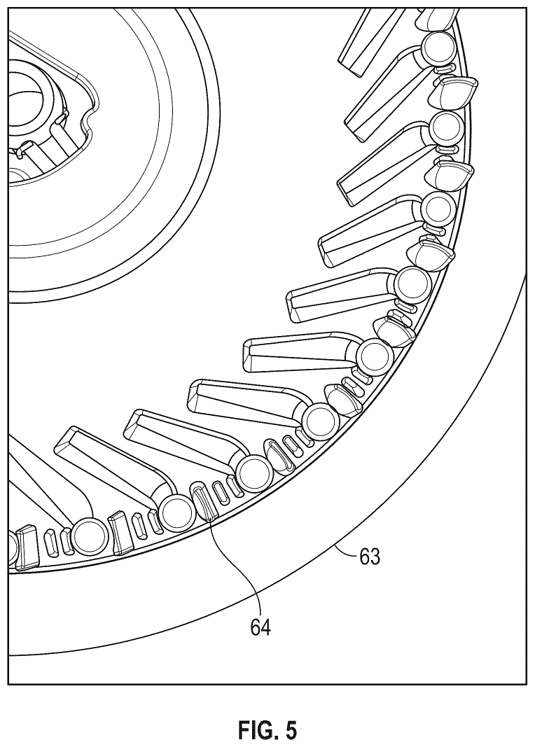

FIG. 5 shows additional aspects of the disclosure. FIG. 5 shows a seed disk 63 that traditionally used for planting corn per the disclosure of the '072 patent. To easily change from planting corn to planting cereal type seeds, the seed cells of the disk 63 have been closed off. The disk already includes paddles 64 that will be used to meter and direct the seeds in the meter, such as in the second configuration (different rotation).

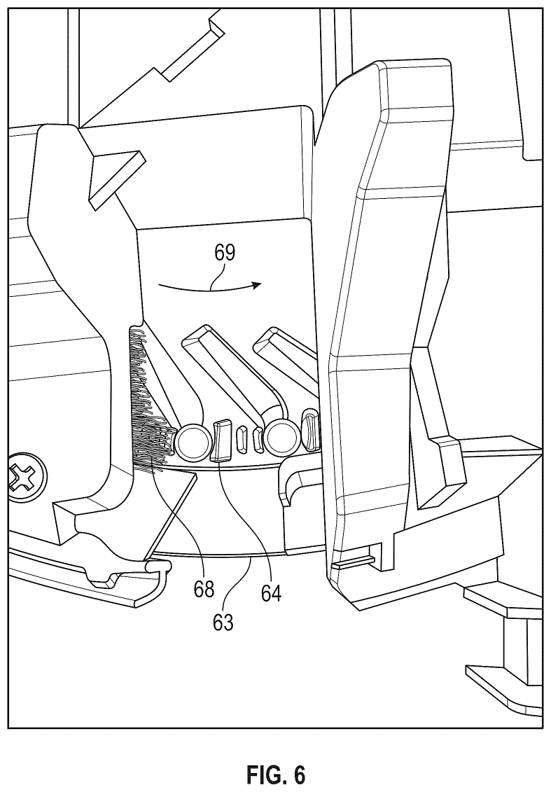

FIG. 6 is a depiction of the seed disk 63 shown in FIG. 5 in operation. The figure shows that the disk will move in the direction of the arrow 69. The brush 68 will aid in controlling the number of seeds held between adjacent/subsequent paddles 64 to control the release of seeds from the meter.

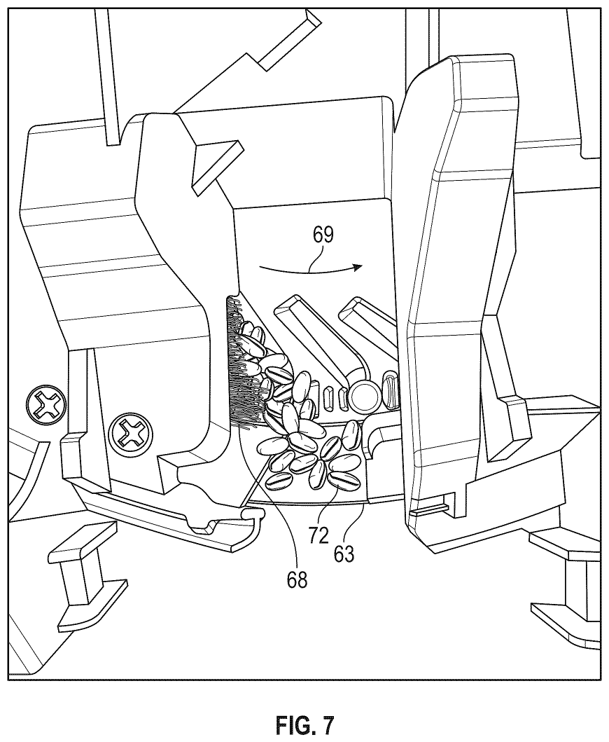

FIG. 7 is another depiction in the form of a still shot where seed 72 is shown being moved and released from the meter. Again, the arrow 69 shows the rotational direction of the disk 63 and the figure also shows how the paddles are used to control the population of seeds that are moved and released from the meter.

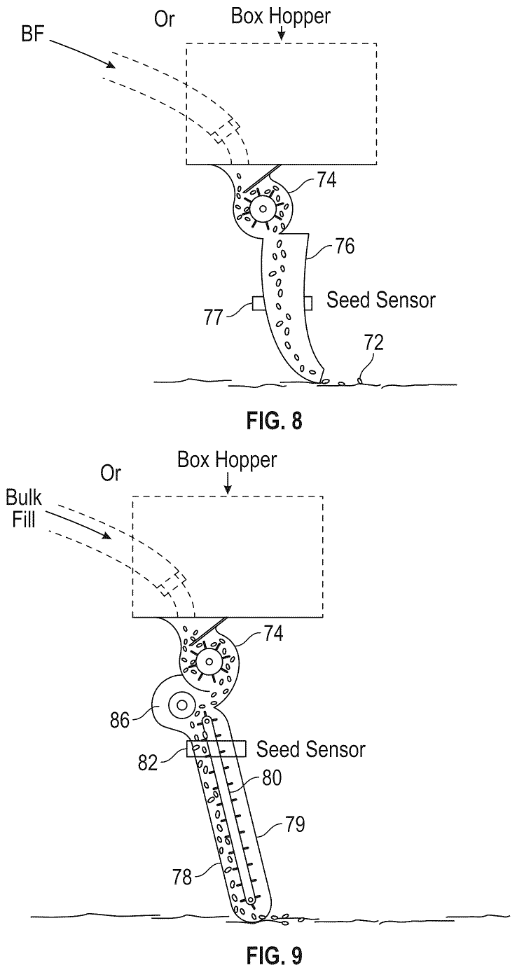

Moving to FIG. 8, additional aspects of the disclosure are shown. While some aspects of the disclosure have shown that a common meter can be used in different configurations to meter and release different seed varieties or types, FIGS. 8 and 9 are depictions of how the seed that has been metered and released via the seed meter can be directed towards the ground, such as in a furrow created in the ground.

As shown in FIG. 8, seed 72 is delivered to a row unit via a bulk fill system or a box hopper (on row hopper). The seed can then be metered via the meters 50/60 shown herein, or can be metered via a fluted seed roller 74, which is used in current volumetric seeding operations (seed drills, etc.). The roller could be in the form of a fluted roller, cup wheel, belt meter, brush meter, etc. Any of the meter types can be powered with the electric motor that is already found on seed meters, such as that precision planting type.

Regardless of the meter type, the seed that has been metered can be passed into a gravity seed tube 76, which is sized and shaped to direct the seed 72 towards the ground. The seed tube 76 is designed to account for the gravitational constant of acceleration and shaped to mitigate bouncing, which will control the amount of seeds and how they are spaced in the field. A seed sensor 77 is also shown. The seed sensor 77 can be a stereo sensor, radio wave sensor, microwave sensor, light sensor, optic sensor, LiDAR, Radar, or any other type of sensor that is used to determine if a seed has passed, including how many seeds are being released. This will aid in controlling the seed, such as by rotational speed of the disk or other means. In addition, the meter control can be done via meter speed (rotational speed), baffle door, metering wheel 74 geometry, or the width of the fluted seed roller meter 74. Any of these would affect the number of seeds being released.

FIG. 9 shows another iteration of seed to ground. As shown in the figure, seed 72 is fed into a meter, which may be a meter shown in FIG. 3 or 4, or may be a fluted seed roller meter 74. The seed can be provided via bulk fill or on-row seed hopper. The metering wheel 74 feeds the seed 72 into a delivery system 78. As shown in FIG. 9, the delivery system 78 is a controlled seed to ground system that includes an electrically driven endless member 80 (e.g., brush wheel, flighted wheel, brush belt, flighted belt, etc.) that is driven by an electric motor 86. The endless member 80 is within a housing 79 to mitigate outside forces from acting on the system. The endless member 80 is rotated at a speed that corresponds with a ground speed of the implement. This will allow seed that is dispensed from the system 78 to include a horizontal vector component that is equal to and opposite of the horizontal velocity of the implement, which will mitigate movement or bounce of the seed as it is placed in the furrow. Additionally, the system 78 includes a seed sensor 82 that allows the amount of seed to be determined in the system 78 for further control and monitoring.

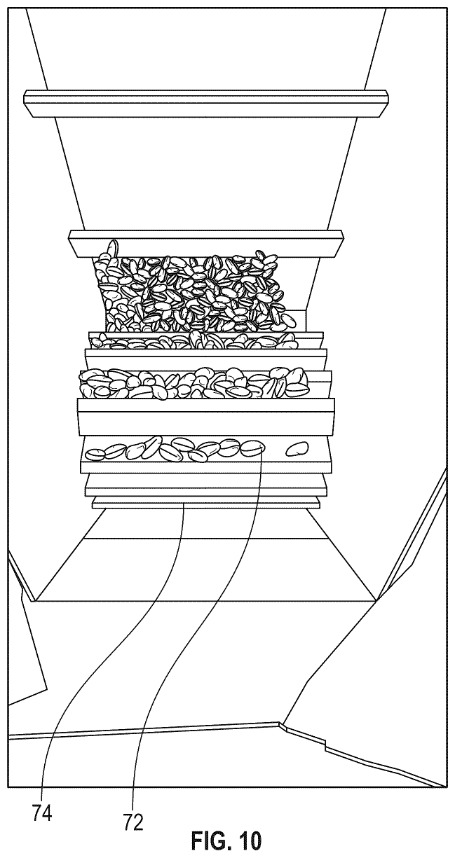

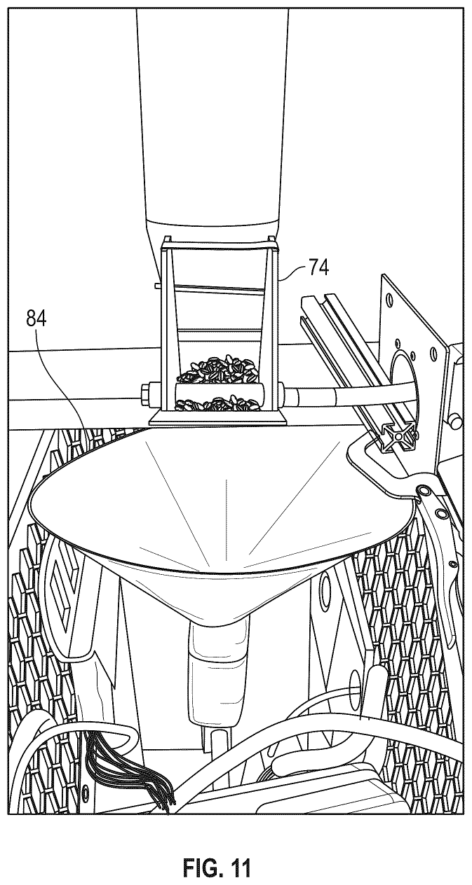

FIG. 10 is a depiction of seed 72 that is being metered via a fluted seed roller 74 of the type disclosed herein. As noted, this is but one type of meter that could be used with many of the aspects of many of the embodiments. FIG. 11 is another depiction of the systems shown and described herein and include a funnel 84 between the fluted meter 74 and the seed to ground system, which mitigates seed from spilling or moving in an unwanted area.

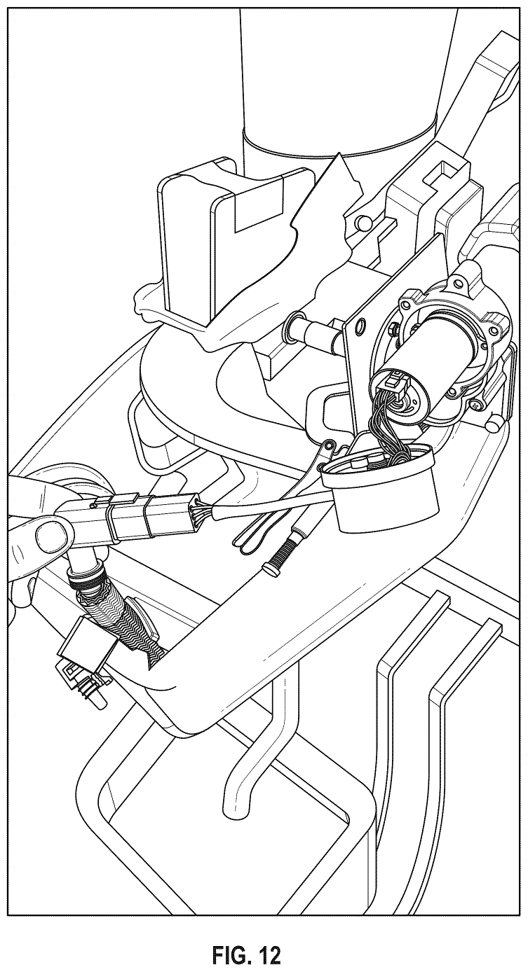

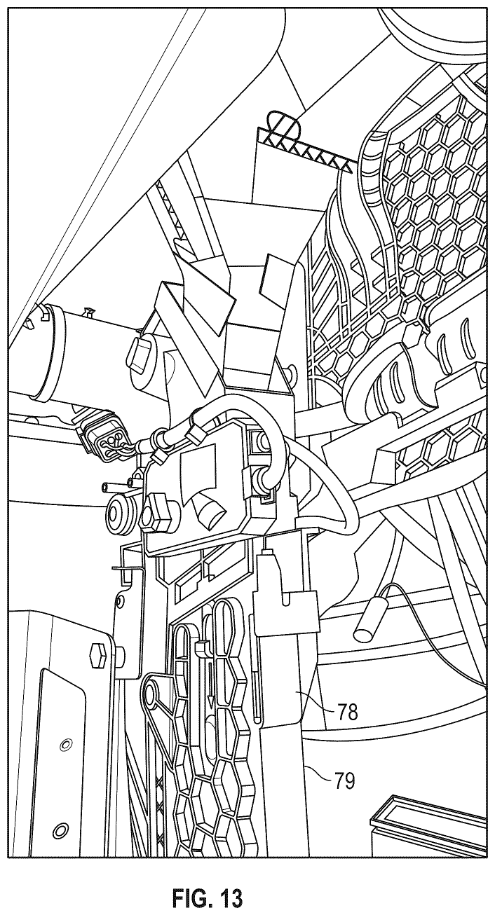

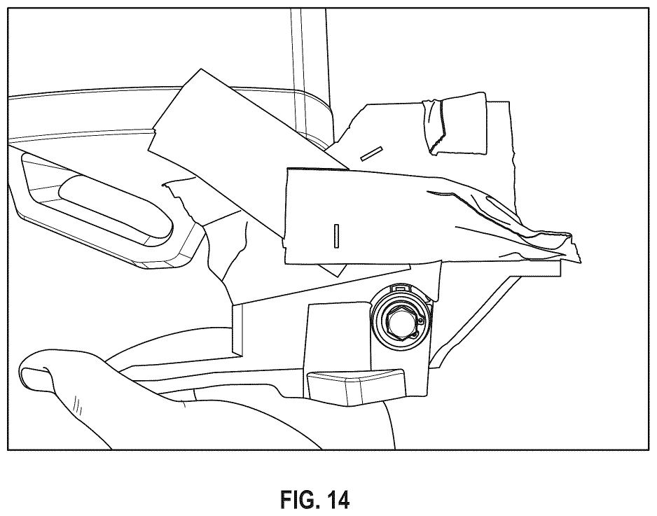

FIGS. 12-14 show additional aspects of embodiments, including the electric motor used to drive the fluted meter 74. FIG. 13 includes the fluted meter 74 connected to the controlled seed to ground delivery system 78, as shown in FIG. 9.

Additional aspects, considerations, and/or embodiments of the disclosure are also provided. For example, while it has been included that any of the seed meters operate in first and second configurations with the seed disks rotating in opposite directions, this need not be required in all circumstances. Additional embodiments include the fac that the seed meter systems can provide the advantages posed herein while the seed disk only rotate in a single direction. It should be appreciated that a volumetric seed disk design is used that rotates in the same direction as an air seed disk.

Take, for example, the seed disk 63 shown in FIGS. 4A-4D. The paddles 64 are oriented in part based on the rotational direction of the disk 63 in the meter 60. However, in some embodiments, the paddles 64 could be oriented in a different manner if the disk 63 were to rotate in the same direction as shown by the arrow 59 in FIG. 3D. The orientation of the paddles 64 would allow an amount of seed to be collected between adjacent paddles as the paddles 63 move through a seed pool. An insert, such as the insert 67 in the figures, could be included at or near a three o'clock position as shown in FIG. 4D. The insert 67 would create an interior wall to for a cavity with the outer wall of the housing and adjacent paddles, which would essentially mitigate seed from falling from the adjacent paddles (e.g., under gravity) until such time that it is desired. This could be after the insert 67, wherein the seed would be essentially dropped under gravity into the seed chute and towards a seed tube or controlled seed to ground delivery system.

Still other manners of allowing a seed disk to rotate in a single direction while still allowing the disk to be used as an air seed meter or a volumetric seed disk and meter are to be considered a part of the disclosure. This goes for any of the seed meters, disks, and/or seed to ground systems. This includes both the gravity style seed tube and the controlled seed tube with an endless member, belt (flighted or otherwise), brush wheel, brush belt, etc. The rotation of the seed disk in the meter housing should not necessarily be limiting on the disclosure as a whole.

Still further, it is noted that the disclosure has referred to electric motors for operating aspects of the implements, including to provide rotation to the seed disks in the seed meters and operating aspects of the seed to ground seed delivery systems. However, the present disclosure envisions that this is not the sole way to operate the components presented, such as those related to the operation of the row units.

For example, as is known in the industry, seed meters, delivery belts/brushes, roller meters, etc. could also be operated in other manners. Such manners can include, but should not be limited to, ground driven systems. Such ground driven system can include a rolling member or the like that translates the speed of the implement moving through a field to the rotating disk, delivery belt, or other components. Such rolling member can be directly connected to the rotating components, such as via chain, belt, or other mechanism. In addition, clutches and/or gears can be included in the connection to further control the rotational speed of the components based upon the ground driven member, such as to step up or step down the ground speed to the driven components. Therefore, any of the aspects, components, etc. presented herein that are shown and/or described as being driven via an electric motor could also be driven in a mechanical manner, such as by a ground driven system to impart a rotational speed thereto.

As understood, the operation as disclosed provides for simple operation, the elimination of vacuum (or positive pressure) while planting, and fewer moving and wear parts. The swapping of the seed meter type will also allow for higher planting population rates at higher planting speeds, providing an advantage to farmers so they can actually plant full rate population at speeds they currently do today with an air drill, and also increases the customer potential for the seed meters.

Therefore, the disclosure includes numerous embodiments and/or aspects that provide advantages over the prior art. Seed meters include the ability to be operated as volumetric brush/cereal type meters, and can also operate for metered seeds, such as corn and soybeans. The air pressure seed meter can be run without the pressure source and the disk can be operated in an opposite direction. A swappable insert is used to control the seed to the ground. These minor changes allow the seed meter to be used as a high volume rate seed meter, which can provide better performance for cover crops and blended seed mixtures.

It should be noted that any of the components of any of the aspects and/or embodiments provided can be combined with other components, even if not explicitly disclosed, to create yet additional embodiments that are within the scope of the present disclosure. In addition, variations and alternatives obvious to those skilled in the art are to be considered a part of the present disclosure.

1. A seed meter for use with an agricultural implement, comprising:
a seed meter housing;
a seed disk rotatably mounted in the seed meter housing;
wherein the seed meter operable in a first configuration wherein the seed disk rotates in a first direction to meter and release seeds, and a second configuration wherein the seed disk rotates in a second direction that is opposite the first direction to meter and release seeds.

2. The seed meter of claim 1, wherein in the first configuration, the seed disk is an air seed disk utilizing an air pressure differential to hold seeds at the disk.

3. The seed meter of claim 2, further comprising a seed singulator to regulate seed at seed cells of the seed disk.

4. The seed meter of claim 1, wherein in the second configuration, the seed disk is a volumetric seed disk comprising a plurality of radially spaced paddles and wherein seed is held between subsequent paddles during movement of the disk.

5. The seed meter of claim 4, further comprising a brush block insert near a discharge point to direct seed towards the discharge point in the seed meter housing.

6. The seed meter of claim 5, wherein the brush block insert include a brush to aid in controlling the number of seeds between subsequent paddles.

7. The seed meter of claim 1, wherein the seed meter housing comprises a seed chute for directing seeds from the seed meter.

8. The seed meter of claim 1, further comprising a seed tube adjacent the seed meter housing to receive seed from the seed meter and to direct towards a furrow.

9. The seed meter of claim 1, further comprising a seed to ground system adjacent the seed meter, the seed to ground system comprising a housing with an endless member therein, the endless member to control the movement of the seed from the seed meter through the housing and to the ground.

10. The seed meter of claim 9, wherein the endless member of the seed to ground system is rotatable in a speed wherein the release of the seed therefrom includes a horizontal velocity that is equal and opposite to a horizontal speed of the agricultural implement.

11. The seed meter of claim 8, wherein the endless member comprises a flighted belt.

12. The seed meter of claim 8, wherein the endless member is connected to an electric motor to provide movement for the endless member.

13. A seed meter, comprising:
a seed meter housing;
a first seed disk capable of being rotatably mounted in the seed meter housing; and
a second seed disk capable of being rotatably mounted in the seed meter housing;
wherein the first seed disk is selected when the seed meter is operated as an air seed meter;
wherein the second seed disk is selected when the seed meter is operated as a volumetric seed meter; and
wherein the first and second seed disks are rotated in the same or opposite directions in the seed meter housing.

14. The seed meter of claim 13, wherein the first seed disk comprises a plurality of radially spaced seed cells comprising apertures passing through the seed disk.

15. The seed meter of claim 13, wherein the second seed disk comprises a plurality of radially spaced paddles to hold a volume of seed therebetween as the second seed disk rotates in the seed meter.

16. The seed meter of claim 13, wherein the seed meter housing comprises a seed chute for directing seeds from the seed meter.

17. The seed meter of claim 13, further comprising a seed tube adjacent the seed meter housing to receive seed from the seed meter and to direct towards a furrow.

18. The seed meter of claim 13, further comprising a seed to ground system adjacent the seed meter, the seed to ground system comprising a housing with an endless member therein, the endless member to control the movement of the seed from the seed meter through the housing and to the ground.

19. The seed meter of claim 18, wherein the endless member of the seed to ground system is rotatable in a speed wherein the release of the seed therefrom includes a horizontal velocity that is equal and opposite to a horizontal speed of the agricultural implement.
